(19) United States
(12) Patent Application Publication
(10) Pub. No.: US 2007/0213944 A1
(43) Pub. Date: Sep. 13, 2007

(54) Fluid flow analyzing method, fluid flow analyzing system, recording medium for recording program for functioning computer as fluid flow analyzing system, and computer data signals showing fluid flow analyzing program

(75) Inventors: Teruo Matsuzawa, Nomi-shi (JP); Kiyoshi Kumahata, Nomi-shi (JP)

Correspondence Address: KANESAKA BERNER AND PARTNERS LLP, 1700 DIAGONAL RD, SUITE 310, ALEXANDRIA, VA, 22314-2848, US

(73) Assignee: JAPAN ADVANCED INSTITUTE OF SCIENCE AND TECHNOLOGY, Nomi-shi (JP)

(21) Appl. No.: 11/701,356

(22) Filed: Feb. 2, 2007

(30) Foreign Application Priority Data
Feb. 28, 2006 (JP) 2006-053293

(51) Int. Cl. G01F 7/00; G06F 17/10

(52) U.S. Cl. 702/45; 702/127; 702/1; 702/189

(57) ABSTRACT

The flow of a fluid through the whole of a structure is easily analyzed by a process that comprises separating and dividing the computation of flow along the course of the fluid flowing in the structure and superpositioning the results of analysis.
The fluid flow analyzing system used for this analysis is furnished with a fluid flow analyzing step that comprises subjecting the flow induced in the structure by the fluid flowing in the structure to analytical computation with a computer by using the following linear equation and obtaining the result of this analysis.

$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$

The analytical computation is carried out in the sequence of steps shown in FIG. 8.

### BACKGROUND OF THE INVENTION AND RELATED ART STATEMENT

This invention relates to a method for analyzing fluid flow, a system for analyzing fluid flow, a recording medium for containing a program for functioning a computer as a fluid flow analyzing system, and a transmitting medium for enabling transmission of a fluid flow analyzing program, which are aimed to expeditiously and conveniently simulate the phenomenon of the flow of a fluid (gas or liquid) within a structure with a computer.

When such a structure as a house is designed, for example, the estimation of the flow of wind within the house is useful for designing a building structure because flow of wind in the house depends on the shape of house, the allocation of room, and the arrangement of the furniture. When air conditioners and articles of furniture are installed in a house, the ability to estimate the flow of wind in the house after the air-conditioner installed in the house enables to install the air conditioner at the most suitable position from the viewpoint of the efficiency of energy.

As a means of estimating the flow of fluid (including wind) in the structure such as a house, the method of estimation that utilizes the thermal air flow analyzing system disclosed in Patent Document 1 may be cited, for example. The thermal air flow analyzing system of Patent Document 1 is furnished with a room shape model preparation means 11 for preparing a room shape model by inputting shape of a structure (building), a mesh creation means 12 for creating meshes according to the prepared room shape model, an analysis means 13 for numerical analysis of fluid flow based on the meshes prepared by the mesh creation method 12, and an output means 14 for outputting as the results of the analysis by the analyzing means 13. The output is the data of the aerial environment including the conditions of distribution and the hourly changes of temperature, air flow, and concentration at the inside and outside of the house. When this system is installed in a computer, the input of various kinds of data mentioned above enables analytic computation of the flow (wind velocity and wind direction) in the building and allows the results of this analysis to be visualized on the display screen of the computer.

[Patent Document 1] JP-A 2002-56039

The flow analyzing system that is represented by the fluid flow analyzing system disclosed in Patent Document 1 mentioned above uses as an equation that describe flow behavior during the simulation the following formula (2), which is a nonlinear equation (called Navier-Strokes equation) including a term of advection and diffusion, because it assumes the flow (wind flow) as an incompressible viscous flow.

$$\frac{\partial u}{\partial t} + ( u \cdot ∇ ) u = - ∇ p + \frac{1}{Re} Δ u \qquad Formula ( 2 )$$

In the formula, u denotes the vector of the velocity of flow, p denotes the pressure, and Re denotes the Reynolds Number. This equation can be applied to the general complicated fluid behavior such as vortexes and turbulent flows and can acquire exact values as the results of computation. On the other hand, since it is a nonlinear equation, it requires a fine mesh division for the sake of converging a solution. While a complicated phenomenon is induced in the neighborhood of a wall, the fine mesh division also becomes necessary for the sake of expressing the phenomenon. The analyzing system disclosed in Patent Document 1 also implements the fine mesh division with the mesh preparing means 12 to improve the efficiency of the fluid flow analysis. Further, since this equation is a non-linear equation, even when the fluid flows in the interior of a house via a plurality of openings, the equation is incapable of acquiring the whole result of analysis by performing the analytic computation for each of the inflow openings and superpositioning the results of analysis consequently obtained. No matter whether the interior of a house is separated into a plurality of rooms or not, therefore, it is necessary that the whole house be regarded as one continuous space and the analytic computation is performed by applying formula (2) to all the flows in the continuous space. Generally, the computation amount of a fluid simulation is in proportion to the third power of the volume of a continuous space being analyzed. Therefore, analytic computing without separation of the continuous space into some separated spaces needs huge time for the computation. Thus, the use of a general personal computer for the analysis under discussion becomes difficult. Even if this analytic computation is performed, the time required for the computation is unduly long because the computation amount is enormous.

This invention, therefore, is aimed at providing a fluid flow analyzing method, and a program for enabling a computer to function as a fluid flow analyzing system. It enables a copious reduction in the computation amount and realizes expeditious and convenient simulation as compared with the conventional method by utilizing the aforementioned relation between the computation amount and the volume of spaces subjected to be analyzed, performing the analytic computation of flows in a house not collectively wholly but sequentially along the flows in the separated spaces of the house, and superpositioning the results of analytic computation performed separately on the individual flows for branched of flows and plurality of inflows.

Further objects and advantages of the invention will be apparent from the following description of the invention.

### SUMMARY OF THE INVENTION

The present inventors have taken notice of the fact that the aspects of movement of a fluid (gas or liquid) change by the ratio of the inertial force to the viscous force and the influence of the viscous force exerted on the movement of the fluid decreases in accordance as the ratio of the inertial force to the viscous force increases. Generally, it is known that the flow (air, wind, etc.) in a structure exhibits an inertial force that is several thousand or more times as strong as a viscous force. This fact has led the present inventors to an assumption that the flows in the structure are not influenced by the viscous force but influenced solely by the inertial force. Further, the present inventors have resolved to adopt not the conventional nonlinear equation (Navier-Stokes equation) but the linear equation (velocity potential equation) for formulating the analysis of fluid flow in the interior of a structure because the movement of the fluid in the structure can be defined by the linear equation (velocity potential equation) owing to the law of conservation of mass (a fluid that has flowed in a structure neither increases nor decreases in the structure but possesses a fixed mass constantly) and the aforementioned assumption.

That is, the fluid flow analyzing method contemplated by this invention is a method for the analysis of fluid flow that is aimed to simulate the phenomenon of fluid (gas or liquid) flow in a structure with a computer and is characterized by possessing a fluid flow analyzing step that analysis fluid flow in the structure due to the wind by analytically computing with a computer by solving the following linear equation

$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$

and acquiring the result of the analysis. The term “structure” as used herein refers not only to such a structure as a house but also to such a structure as encircles a multiplicity of irregularly disposed houses. The analytical computation, therefore, can be applied to a multistory building and also to the flow of a fluid in a piping laid in a complicated pattern in a chemical plant, for example.

According to this invention, since a prescribed linear equation is adopted for the analysis of a fluid flow in a structure, the amount of computation with a computer is small and the results of the analysis can be obtained in a short time as compared with the conventional analysis using a nonlinear equation.

In the fluid simulation, the amount of computation involved therein is in proportion to the third power of the volume of space to be analyzed as described above. In this invention, the number of times of analysis increases by sequentially computing in the separated spaces along the course of the fluid flow, however the total computation amount can greatly decrease because the total of the third power of the volume of a separated space involved in each analysis is much smaller than the third power of the volume of continuous space.

This invention is configured as two steps. When the structure mentioned above has plurality inflow or the structure can be separated into separated space, one step separately computes each flow regarded as individual. And other step performs superpositioning the results of separated computation.

According to this invention, even when the fluid flows in the structure from a plurality of portions (when the house has a plurality of opening i.e. windows or doors and the wind to enter in the house from the plurality of windows or doors), since the linear equation by nature allows the plurality of results of analysis to be superpositioned, the fluid flow in the structure can be easily analyzed by computation separately on each of the inflows and superpositioning the separate results of analysis.

The fluid flow analyzing system contemplated by this invention is a system for the analysis of a fluid flow that is aimed to simulate with a computer the phenomenon of the flow of a fluid (gas or liquid) in a structure and characterized by possessing a means to analyze the flow of a fluid in the structure by analytic computation using the following linear equation;

$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$

Then, the recording medium of this invention capable of being read from a computer having record a program for functioning the computer as a fluid flow analyzing system is a recording medium that has recorded a fluid flow analyzing program aimed to simulate with a computer the phenomenon of the flow of a fluid (gas or liquid) in a structure and is characterized by possessing a fluid flow analyzing step of analytically computing the flow induced by the fluid flowing in the structure by using the aforementioned prescribed linear equation (FORMULA (1)). Further, the computer data signal of this invention expressing a program for functioning a computer as a fluid flow analyzing system is a computer data signal expressing a fluid flow analyzing program for simulating with a computer the phenomenon of the flow of a fluid (gas or liquid) in a structure and embedded in a signal carrier wave is characterized by expressing a fluid flow analyzing program for functioning a computer so as to comprise a fluid flow analyzing step of analytically computing the flow induced by the fluid flowing in the structure by using the aforementioned prescribed linear equation (FORMULA (1)).

Since this invention possesses a fluid flow analyzing means adopting a prescribed linear equation for formulating the analysis of the flow of a fluid in a structure, it permits devising a fluid flow analyzing system that is capable of decreasing the computation amount and obtaining the result of analysis in a short time as compared with the conventional system adopting a nonlinear equation. Further, this invention, by having a computer function so as to comprise a step of fluid flow analyzing means adopting a prescribed linear equation for formulating the analysis of the flow of fluid in a structure, is enabled to provide a recording medium having record therein a fluid flow analyzing program capable of decreasing the amount of computation and obtaining the results of analysis in a short time as compared with the conventional recording medium adopting a nonlinear equation and a computer data signal that delineates the program mentioned above.

The configuration described above, by setting such conditions as the arrangement of the rooms in a house, the positions and the numbers of windows and doors, and the direction and the velocity of wind, is enabled easily to analyze the velocity, direction, and amount of the flow of wind in a short time, no matter what shape and size the structure may possess.

In simulating the flow of a fluid (gas or liquid) in a structure according to the fluid flow analyzing method, the fluid flow analyzing system, the recording medium capable of being read from a computer having record a program for functioning the computer as a fluid flow analyzing system, and the computer data signal delineating a program for functioning a computer as a fluid flow analyzing system that are contemplated by this invention, when such conditions as the arrangements of the rooms in a house, the positions and the numbers of windows and doors, and the direction and the velocity of wind are set, an general personal computer instead of a high-performance computer can analyze the fluid flow in several minutes, no matter what shape and size the structure may possess. When the fluid flow analyzing method of this invention is incorporated in the building CAD, since the flow of a fluid (wind) in a structure is automatically predicted from the CAD drawing, an architect who has no special knowledge of the numeric fluid dynamic simulation can predict the flow in the structure expeditiously in a low cost and utilize the results of this prediction in designing a structure while taking into consideration the layout of household effects and the location of air conditioners.

### BRIEF DESCRIPTION OF THE DRAWINGS

FIG. 1 is a block diagram of a fluid flow analyzing system.

FIG. 2 is an example showing a structure to be simulated by this invention.

FIG. 3 is an overall view of the structure mentioned above.

FIG. 4 (a) is a table showing positional data (origin points and lengths) of various objects in the structure mentioned above. And FIG. 4 (b) is a diagram showing the data that which opening parts belong to which room, and which room has which opening parts.

FIG. 5 is a diagram expressing abstract relationship of rooms and opening parts in graph expression.

FIG. 6 (a) is a diagram expressing the flow order in one of a plurality of inflow patterns. FIG. 6 (b) is a diagram expressing the flow order in another one of a plurality of inflow patterns.

FIG. 7 is a diagram showing the process for deciding the order of computation. FIG. 7 (a) is a diagram showing the room groups B2 and B4 that are not yet included in the order of computation when the room B3 is selected subsequent to the room B1 having an inflow. FIG. 7 (b) is a diagram showing the room groups B3 and B4 that are not yet included in the order of computation when the room B2 is selected subsequent to the room B1 having an inflow. FIG. 7 (c) is a diagram showing the room groups B1 and B3 that are not yet included in the order of computation when the room B4 is selected subsequent to the room B2 having an inflow. FIG. 7 (d) is a diagram showing the room groups B3 and b4 that are not yet included in the order of computation when the room B1 is selected subsequent to the room B2 having an inflow.

FIG. 8 is a flow chart showing the process of fluid flow analysis according to the fluid flow analyzing system of this invention.

FIG. 9 is an example representing directions of flow relative to one inflow to the room to which the mode of embodiment is applied.

FIG. 10 is an example representing directions of flow relative to a plurality of inflows to the room to which the mode of embodiment is applied.

FIG. 11 (a) is an example representing a structure to which the mode of embodiment is applied and the directions of flows into and out of the structure. FIG. 11 (b) is a diagram expressing the data the opening parts possess in common by using nodes and edges. FIG. 11 (c) is a diagram showing the process for deciding the order of computation. FIG. 11 (d) is a diagram showing the process for deciding the order of computation, namely a drawing showing the room groups B16 and B19 that are not yet included in the sequence of computation relative to the selected room B18. FIG. 11 (e) is a diagram showing the process for deciding the order of computation, namely a drawing showing the room groups B18 and B19 that are not yet included in the sequence of computation relative to the selected room B16.

FIG. 12 is a block diagram showing one configuration of the fluid flow analyzing system according to the mode of embodiment.

### DETAILED DESCRIPTION OF THE EMBODIMENTS

Now, the modes of embodiment this invention will be described below by reference to the accompanying drawings.

The modes of embodiment concern a method for the analysis of fluid flow most suitable for analyzing the flow of wind (velocity of wind and direction of wind) in a building structure, a fluid flow analyzing system, a recording medium capable of being read from computer having the record a program for functioning the computer as a fluid flow analyzing system, and a computer data signal delineating a program for functioning a computer as a fluid flow analyzing system.

(Fluid Flow Analyzing System of this Invention)

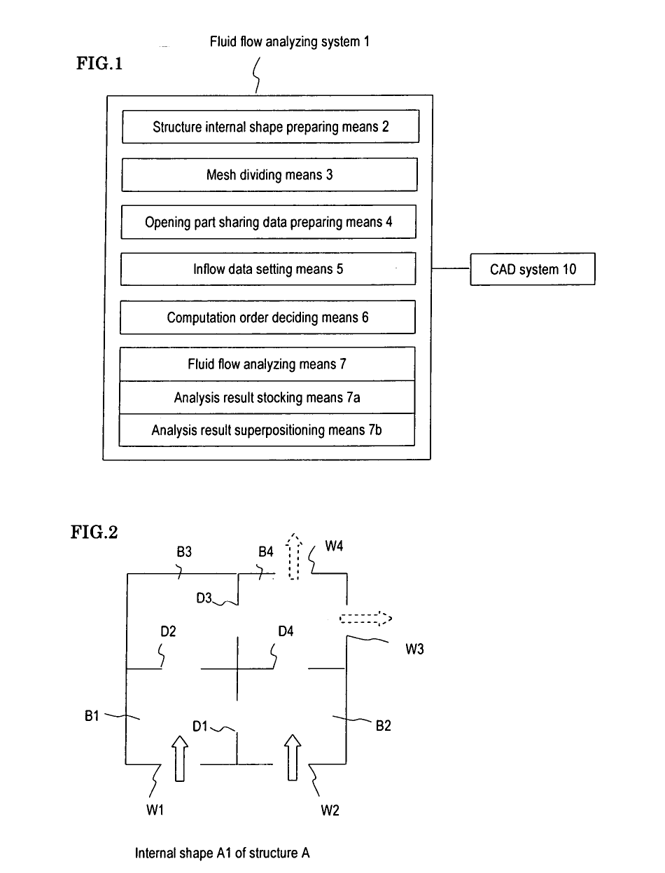

The mode of this embodiment concerns a fluid flow analyzing system 1 (FIG. 1) directed to simulate the phenomenon of a flow in a structure with a computer.

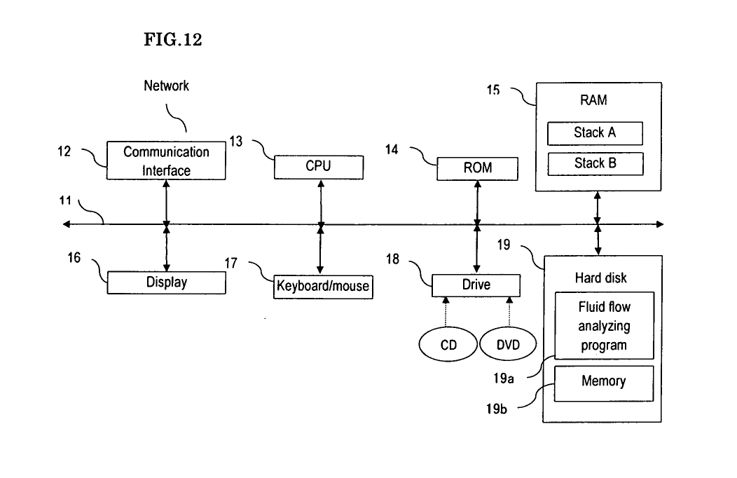

FIG. 12 is a block diagram showing one configuration of a fluid flow analyzing system 1 according to the first mode of embodiment of this invention. The fluid flow analyzing system 1 according to the first mode of embodiment has a communication interface 12, a CPU 13, a ROM 14, a RAM 15, a display 9, a keyboard/mouse 8, a drive 18, and a hard disc 19 connected to an internal bus 11 so as to implement transmission of address signal, control signal, data, etc. and configure a computer system for realizing a fluid flow analyzing system according to this mode of embodiment.

The communication interface 12 is furnished with various communication functions for connection to such communication networks as an internet and is enabled to download a program 19a for imparting functions to the following various means 2 to 7. The CPU 13 controls the whole system in accordance with the OS stored in the ROM 14 and as well manages the function of executing the process based on the program stored in the hard disk 19.

The ROM 14 has stored therein such programs as the OS for controlling the whole system and is has the function of feeding the programs to the CPU 13. The RAM 15 has a memory function that is utilized as a work area during the execution of these various programs by the CPU 13.

The display 9 has the function of graphically displaying the internal shape of a structure and the flow of a fluid that will be specifically described herein below, based on the instruction from the CPU 13. The keyboard/mouse 8 is capable of inputting data of characters, numeric characters, and symbols and inputting coordinate data by manipulating the point position in the screen as well.

The drive 18 is a driving unit for executing the operation of installing various programs and data from such recording mediums as CD and DVD that have recorded them therein. It is also capable of installing from the memory medium the program 19a enabling a computer to function as the fluid flow analyzing system 1.

The hard disk 19 is an external memory device for storing various data such as the program 19a and a memory 19b. The program 19a is equivalent to what has memorized the programs in executable format, installed from the communication interface 12, the drive 18, etc as mentioned above. The memory 19b is a memory part that preserves the files of the results of execution of various programs and the results of analysis.

The fluid flow analyzing system 1 is capable of being connected to the CAD or incorporated in the CAD, utilizing various kinds of data such as the coordinate data of a CAD system 10, and visualizing graphically various kinds of data with the CAD system 10. The CAD system 10 has the hard disk 19 store a program for enabling itself to function as a CAD system and is realized with the same computer as the fluid flow analyzing system 1 by causing the CPU to execute its process in accordance with the instruction of the program. Incidentally, the fluid flow analyzing system 1 of this invention may have the CAD system 10 incorporated in the analyzing system as part of the analyzing system, may be incorporated in the CAD system 10 as part of the CAD system 10, or may be connected to the CAD system that is independent.

The fluid flow analyzing system 1 is provided with a fluid flow analyzing means 7 that analytically computes the flow (velocity and direction of flow) induced in a structure by a fluid entering into the structure by using a prescribed linear equation and acquires the result of this analysis. The mode of this embodiment comprises a structure internal shape preparing means 2 for preparing the internal shape of a structure, a mesh dividing means 3 for subjecting the structure interior to mesh division based on the internal shape prepared by the structure internal shape preparing means 2, an opening part sharing data preparing means 4 for preparing an opening part sharing data answering the question whether the adjacent individual rooms share an opening part based on the internal shape prepared by the structure shape preparing means 2, and a computation order deciding means 6 for deciding the order of computation from the room the fluid enters first to the room the fluid flows out last based on the opening part sharing data having completed addition of an inflow data. Then, in accordance with the order decided by the computation order deciding means 6, the fluid flow analyzing means 7 mentioned above is performed to implement analytical computation of flows in the blocks. The fluid flow analyzing means 7 is provided with an analysis result stocking means 7a and an analysis result superpositioning means 7b for superpositioning the stocked analysis results.

In the explanation of the mode of this embodiment, the term “structure” refers to a building structure and the expression “the fluid flow in the structure” refers to the air unless otherwise specified. Then, the term “flow” refers to the velocity of flow (velocity of wind)-direction of flow (direction of wind) of the fluid (air) at any point in the structure and may be occasionally expressed as flow (velocity of flow-direction of flow). Particularly, the aforementioned flow of the fluid at the inlet or the outlet of the structure is referred as an inflow or an outflow and may be occasionally expressed as an inflow (velocity of flow-direction of flow) or an outflow (velocity of flow-direction of flow). The expression “the block in a structure” as used herein refers to an continuous separated space with an inner wall, a partition, or an article of furniture such as a room, a corridor, or an entrance hall. In the explanation of the mode of this embodiment, the term “result of analysis” refers as the result of computation obtained by analytic computation. Then, the expression “the flow of a fluid is analyzed” refers to the operation of performing the aforementioned analytical computation under various conditions and obtaining the result of this analysis as a numerical value of velocity and direction of flow.

The fluid flow analyzing means 7 is directed to subjecting the flow (velocity of flow, direction of flow) in a structure induced by the fluid flow into the structure by using a prescribed linear equation and obtaining the result of this analysis. As the prescribed linear equation, the velocity potential equation represented by the following formula is used.

$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$

By adopting this equation as the formula for analysis, it is rendered possible to obtain the result of the whole analysis by performing the flows separated by individual inflows to the analytic computation and superpositioning the results of analysis even when the fluid flows in the structure at a plurality of portions. In the formula, Φ denotes a function called a velocity potential and the velocities u, v, and w in the directions x, y, and z are obtained by [the differentiating φ in each direction. subjecting the Φ to spatial differentiation.

$$u = \frac{\partial Φ}{\partial x} , v = \frac{\partial Φ}{\partial y} , w = \frac{\partial Φ}{\partial z} \qquad Formula ( 3 )$$

When the problem of “obtaining a solution satisfying F (x1+x2)=0” for the linear equation of “F(x)=0,” for example, the solution is attained by a method that comprises first obtaining a solution f1 by solving the problem of F(x1)=0 and then obtaining a solution f2 by solving the problem of F(x2)=0 by utilizing the linearity of the equation and finally obtaining a solution f=f1+f2.

The structure internal shape preparing means 2 is directed to preparing an internal shape A1 of a structure A allowing inflow of a fluid (air) (FIG. 2) based on a prescribed coordinate data entered by the user. The expression “preparing the internal shape A1 of the structure A” as used herein refers as the operation that comprises the user entering the coordinate data of the shape of the structure A (the arrangement of the rooms in a house and the positional data such as the positions for installing doors and windows) and the structure internal shape preparing means 2 preparing the internal shape A1 of the structure A as a gathering of coordinate data based on the entered coordinate data. The size of the structure can be identified in consequence of the entering of origin positions and sizes of such openings as doors and windows. Here, the coordinate data entered by the user may be graphically visualized by the CAD system 10 and then displayed on the display means 9. As the coordinate data to be entered by the user as described above, the coordinate data entered in the CAD system 10 may be used or the structure internal shape prepared by using the entered coordinate data may be transferred to the CAD system, visualized therein, and displayed on the display means 9.

The mesh dividing means 3 divides the interior of the structure A into mesh based on the internal shape A1 prepared by the structure internal shape preparing means 2 mentioned above. When the analytic computation is actually implemented by the fluid flow analyzing means 7 mentioned above, the result of the analysis gains in accuracy in proportion to the fineness of the mesh used for the division, this fineness increases the amount of computation and the time required for the analysis. On the other hand, when the mesh used for the division is coarse, the amount of computation is decreased and the time required for the analysis is shortened, though this coarseness causes degrading the accuracy of the result of analysis. The mode of this embodiment allow an arbitrary designation of the fineness of mesh division and enable designation of the fineness of the mesh depending on the conditions that exist when great weight is placed on time and when great weight is placed on accuracy, for example. The entered data of the fineness of the mesh may be processed graphically in the CAD system 10 and displayed on a display device or the designation of the fineness of the mesh may be entered in the CAD system 10 and the data thereof may be used in the mesh dividing means 3.

The opening part sharing data preparing means 4 is directed to preparing an opening part sharing data answering the question whether the individual adjacent rooms B1 to B4 in the structure A possess openings in common based on the internal shape A1 prepared by the structure shape preparing means 2.

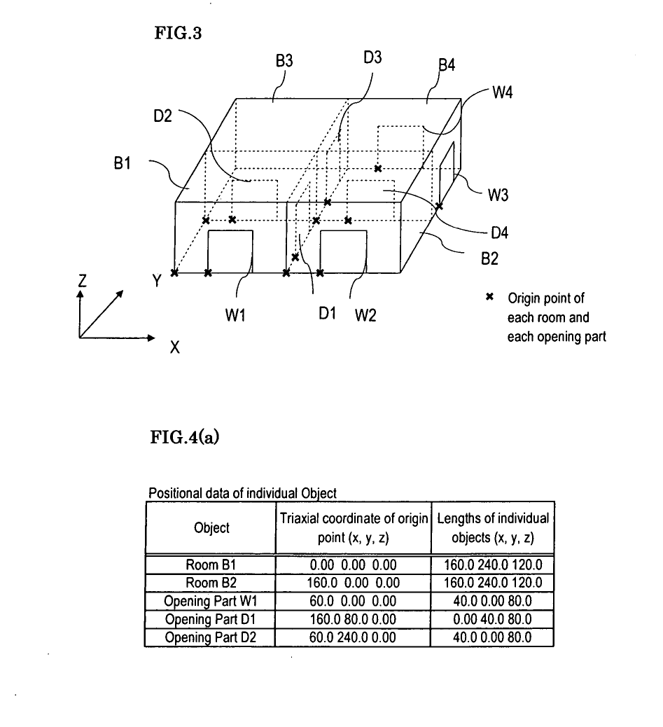

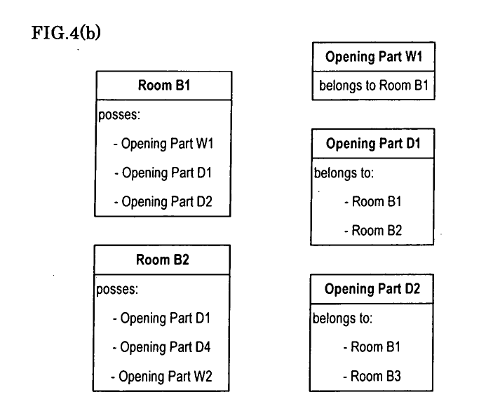

The opening part sharing data preparing means 4, specifically as the first step, compares such object data as opening parts and walls in the internal shape A1 obtained by the structure internal part shape preparing means 2 and prepares the data answering the question which rooms possess which opening parts and which opening parts belong to which rooms. FIG. 3 depicts three-dimensionally the internal shape A1 of the structure A shown in FIG. 2. For example, the positional data of a room B1, a room B2, and opening parts W1, D1, and D2 of the structure A can be expressed by using their respective origin points and dimensions as shown in FIG. 4 (a). By comparing the positional data, it is rendered possible to confirm that the room B1 of the structure A possesses the opening part W1 and the opening parts D1 and D2 and the room B2 possesses the opening parts D1, D4, and W2. It can be confirmed as well that the opening part W1 belongs only to the room B1 and the opening part D2 belongs to both the room B1 and the room B3. Thus, the data as to which opening parts the individual rooms possess and the data as to which rooms the opening parts belong to in the structure A are prepared (FIG. 4 (b)). Here, when the opening parts belong to only one room, this fact allows confirmation that these opening parts are outer opening parts for connection to the exterior and when the opening parts belong to two rooms, this fact allows confirmation that these opening parts are inner opening parts for connection of the two rooms.

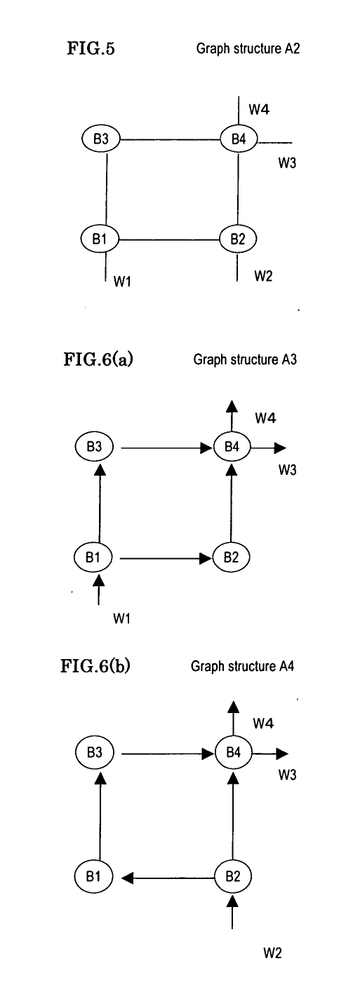

Then, as the next step, the opening part sharing data preparing means 4 prepares an opening part sharing data based on the data as to which opening parts the aforementioned individual rooms B1 to B4 belong to and the data as to which rooms the opening parts W1 to W4 and D1 to D4 belong to. Here, the opening part sharing data can be expressed by a simple graphic structure A2 having the individual rooms B1 to B4 as nodes and the opening parts belonging to the two room as edges (FIG. 5). Here, the opening parts W1 to W4 that severally belong to only one room are represented as edges protruding from the relevant rooms.

An inflow data setting means 5 is directed to deciding inlets•outlets by subjecting the value of flow (velocity of flow, direction of flow) entered by the user to a prescribed rule which will be specifically described herein below and adding the inflow data inclusive of the inlets-outlets to the opening part sharing data prepared by the opening part sharing data preparing means 4 mentioned above. The entered flow data (velocity of flow, direction of flow) may be graphically displayed with the CAD system 10 or may be rendered enterable in the CAD system 10, graphically displayed in the displaying means 9, and enabled to have the flow data used in the inflow data setting means 5.

When the user enters a prescribed flow (velocity of flow, direction of flow) from the south side of a structure (lower part in the bearings of FIG. 2) with reference to FIG. 5, for example, the inflow data setting means 5 mentioned above sets in the aforementioned opening part sharing data the opening parts W1 and W2 of the structure A as the inlets for the fluid possessing a prescribed flow (velocity of flow, direction of flow) by applying the prescribed rule that the outside opening part facing the direction of wind from the magnitude of the flow constitutes the inlet. It also sets the other opening parts W3 and W4 as the outlets for the fluid that has flowed in.

Here, when the fluid flows in through a plurality of opening parts, since the portions of the fluid that flow in through the individual inlets are separately reckoned, the inflow data setting means 5 mentioned above prepares a pattern wherein the relevant inlets are open and the other inlets are shut and adds the inflow data of each of the patterns to the aforementioned opening part sharing data. When the fluid flows into the structure through the opening parts W1 and W2, for example, first on the assumption that the fluid flows into the structure A only through the opening part W1, this inflow data is added to the opening part sharing data. At this time, it is assumed that the other opening part W2 is shut. By using the aforementioned nodes and edges, the opening sharing data of this pattern can be expressed by the graphic structure A4 (FIG. 4 (b)). Incidentally, when the inflow data setting means 5 has prepared a plurality of such patterns, the computation order deciding means 6 decides the sequence of computation for each of these patterns and the aforementioned fluid flow analyzing step 7 carries out the analytic computation in accordance with the sequence of computation for each of the patterns.

The computation order deciding means 6 is directed to deciding the order of computation of the individual rooms from the room the fluid flows in first to the room the fluid flows out last based on the opening part sharing data added to the inflow data. This computation order deciding means 6 has as the basis thereof an adjoining room searching means that implements sequential adjoining search from the room the fluid flows in first to the subsequent adjoining rooms sharing opening parts based on the opening part sharing data having the inflow data set therein. The term “adjoining search” as used herein refers to a method that makes a circle around all the rooms by going through the rooms neighboring the rooms already included in the order of computation and still waiting to joint the sequence of computation in the order of “next→next→ . . . ”. This computation order deciding means 6 is subject to the condition that in deciding the order of computation of rooms during the course of adjoining search, the order of computation of the selected rooms is decided exclusively when at least one outlet exists in the group of rooms excluded from the selected rooms and not yet included in the order of computation.

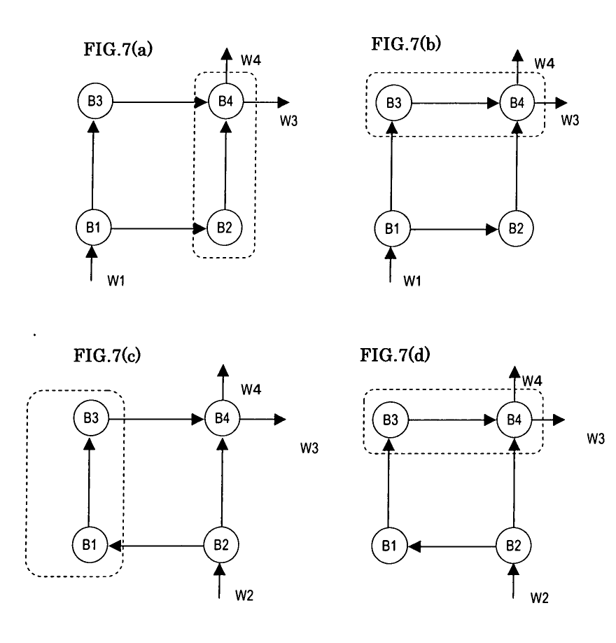

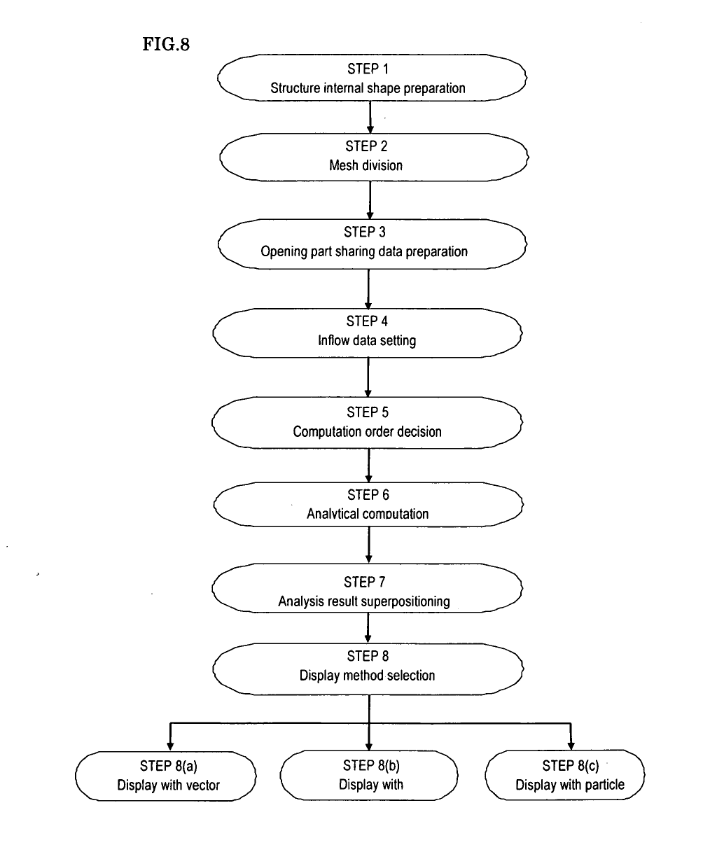

To explain the decision under discussion by reference to the case of allowing the fluid to flow in through the opening parts W1 and W2 mentioned above, first the opening part sharing data of the pattern having the fluid flow in through the opening part W1 can be expressed by the graphic structure A 3 mentioned above (FIG. 6 (a)). When the order of computation is decided based on the opening part sharing data of this pattern, the adjoining search is implemented successively from the room B1 possessing the opening part W1 onward and the rooms B2 and B3 that adjoin the room B1 are picked up as the first step. As the next step, the rooms B2 and B3 so picked up are examined to determine whether they satisfy the aforementioned condition regarding the outlet. First, when the room B3 is selected, the other rooms that are not yet included in the order of computation are the rooms B2 and B4 (FIG. 7 (a)). These rooms B2 and B4 satisfy the condition regarding the aforementioned outlets because the opening parts W3 and W4 fated to become outlets are present. Also when the room B2 is selected, the condition regarding the outlets mentioned above is satisfied because the opening parts W3 and W4 fated to become outlets are present in the other rooms B3 and B4 that are not yet included in the sequence of computation (FIG. 7 (b)). The order of computation decided up to this point is expressed as {B1}, {B2, B3}. No preference exists between the rooms B2 and B3 as regards the order of computation. At the last step, the order of computation of the remaining rooms B4 is decided, with the result that the whole order of computation will be expressed as {B1}, {B2, B3}, {B4}.

On the other hand, the opening part sharing data of the pattern having the fluid flow in through the opening part W2 can be expressed as the graphic structure A4 mentioned above (FIG. 6 (b)). When the order of computation is decided based on the opening part sharing data of this pattern, the adjoining search is implemented successively from the room B2 possessing the opening part W2 onward and the rooms B1 and B4 adjoining the room B2 are picked up as the first step. As the next step, the rooms B1 and B4 so picked up are examined to determine whether they satisfy the condition regarding the outlets mentioned above. First, when the room B4 is selected, the other rooms that are not yet included in the order of computation are the rooms B1 and B3 (FIG. 7 (c)). These rooms B1 and B3 do not satisfy the condition regarding the outlets mentioned above because the opening part fated to become an outlet is not present. On the other hand, when the room B1 is selected, the other rooms B3 and B4 that are not yet included in the order of computation satisfy the condition regarding the outlets mentioned above because the opening parts W3 and W4 fated to become outlets are present therein (FIG. 7 (d)). Thus, the sequence of computation decided up to this point is expressed as {B2}, {B1}. Then, by continuing the adjoining search from the room B1 onward, the whole sequence of computation is decided as {B2}, {B1}, {B3}, {B4}. If the condition regarding the outlets mentioned above is not imposed, the room B4 will be selected earlier than the room B3 and the final order of computation will be expressed as {B2}, {B4, B1}, {B3}. Primarily, when the direction of flow is changed, the room B4 ought to computation order to the room B3, this order causes the fluid to flow from the room B4 to the room B3 and suffers the flow to be stopped in the room B3. To avoid this mishap, the present invention contemplates imposing the condition regarding the outlets mentioned above.

The fluid flow analyzing means 7 is directed to performing the analytical computation sequentially for the individual rooms in the order decided by the computation order deciding means 6 mentioned above. This fluid flow analyzing means 7, when the fluid flows in through a plurality of opening parts and the aforementioned computation order deciding means 6 consequently decides the order of computation for each of the opening part sharing data of a plurality of patterns, carries out the aforementioned analytic computation in accordance with the order of computation found for each of the patterns. This fluid flow analyzing means 7 is provided with an analysis result stocking means 7a for stocking the result of analysis of each inflow of each of the patterns mentioned above by causing the result to be stored in such a memorizing means as a memory and an analysis result superpositioning means 7b for superpositioning the stocked results of analysis. The example to be described below will assume the case of having the fluid flow in through the opening parts W1 and W2. The order of computation of the portions of the fluid are expressed as {B1}, {B2, B3}, {B4} and {B2}, {B1}, {B3}, {B4}. In accordance with the order, first the analytical computation of the flow in the room B1 is carried out with respect to the fluid that has flowed in through the opening part W1. The result of analysis obtained herein is stocked by the analysis result stocking means 7a. Then, since the result of analysis of the room B1 enables decision of the flows (velocity of flow, directions of flow) induced in the opening parts D1 and D2 by the portions of the fluid flowing in the rooms B2 and B3, the result of this decision is utilized for implementing the analytical computation of the flows in the rooms B2 and B3. Then, the result of analysis obtained herein is also stocked by the analysis result stocking means 7a. Finally, since the flows (velocity of flow, directions of flow) induced in the opening parts D3 and D4 by the fluid flowing in the room B4 are decided by the results of analysis of the rooms B2 and B3, the result of this decision is also stocked by the analysis result stocking means 7a. By the same token, the inflow through the opening part W2 is subjected to the analytical computation of flow in the sequence of the rooms B2, B1, B3, and B4 and the results of analysis in the individual rooms are stocked in the aforementioned analysis result stocking means 7a. Finally, the results of analysis obtained from the individual rooms and stored by the analysis result stocking means 7a are superpositioned by the aforementioned analysis result superpositioning means 7b. Consequently, the flow (velocity of flow, direction of flow) induced in the structure A when the fluid having a prescribed flow (velocity of flow, direction of flow) flows in the structure A through the opening parts W1 and W2 can be analyzed. Incidentally, the fluid flow analyzing means 7 accomplishes the computation by adopting a method called finite differential method for imposing proper boundary conditions on the walls, inflows, and outflows. The results of analysis obtained for the individual rooms and stored in the aforementioned analysis result stocking means 7a optionally may be produced as a file on the aforementioned display means 9 so as to allow visual perception of the process of analytical computation of each of the rooms. The result of the analysis by the fluid flow analyzing means 7 may be converted into a graphical data by the CAD system 10 and consequently displayed on the display means 9.

According to the fluid flow analyzing system in the mode of the present embodiment, the analysis of the flow in a house is implemented by performing the relevant computation for each of the rooms (rooms and corridors) of which the house is formed. While the amount of computation required for the analysis of fluid flow is in proportion to the third power of the volume of the empty space being analyzed as described previously, the computation performed for each of the rooms allows a great decrease in the total amount of computation as shown by the formula (4).

$${( {\sum }_{i = 1}^{N} {V}_{i} )}^{3} >> {\sum }_{i = 1}^{N} {V}_{i}^{3} \qquad Formula ( 4 )$$

In this formula, Vi denotes the volume of a room i and N denotes the number of rooms.

Next, the fluid flow analyzing system in the mode of the present embodiment will be applied to various structures with the object of analyzing the flow of a fluid.

In the fluid flow analyzing system of this invention, the analysis of the flow of a fluid is performed along the flow shown in FIG. 8. Specifically, the flow comprises the preparation of the internal shape of a structure by the aforementioned structure internal shape preparing means 2 (step 1)—the mesh division by the aforementioned mesh dividing means 3 (step 2)—the preparation of the opening part sharing data by the aforementioned opening part sharing data preparing means 4 (step 3)—the addition of inflow data by the aforementioned inflow data setting means 5 (step 4)—the setting of the order of computation by the aforementioned calculation sequence deciding means 6 (step 5)—the superpositioning of the results of analysis by the aforementioned analysis result superpositioning means 7b (step 7)—and the selection of a method of display (step 8) sequentially in the order mentioned. Incidentally, the steps 1, 2, and 4 are effected by the user's manual setting of such parameters as shape data, size of mesh division, and direction of velocity of wind. These steps will be sequentially described below. Here, the mode of the present embodiment is such that the component steps 2, 3, and 5 of the fluid flow analyzing system 1 are connected to the CAD system 10 and the coordinate data of the means 2 to 7 are enabled to be visualized on the aforementioned display means 9 by causing the coordinate data produced from the means 2˜7 to be reflected in the coordinate data of the CAD system 10. Then, by causing the coordinate data entered into the CAD system to be reflected in the aforementioned means 2, 3, and 5, it is rendered possible to designate the coordinate point on the display means 9 by using the aforementioned input means 8 and input the coordinate data into the aforementioned means 2, 3, and 5 via the CAD system.

In the preparation of the internal shape of the structure by the aforementioned structure internal shape preparing means 2 (step 1), when the structure internal shape preparing means 2 displays the screen for entering a coordinate on the display means 9 and the user enters a coordinate data via the screen for entering the coordinate, the structure internal shape preparing means 2 prepares the internal shape of a structure by using the entered coordinate data.

In the setting of the mesh division size by the aforementioned mesh dividing means 3 (step 2), the user decides the mesh division size in inches for each x, y, and z direction to be divided and enters the data into the aforementioned mesh dividing means 3. The mesh dividing means 3 implements mesh division based on the data.

In the preparation of the opening part sharing data by the aforementioned opening part sharing data preparing means 4 (step 3), the opening part sharing data preparing means 4 prepares the relative data of possessed•unpossessed between the objects by comparing the coordinate values of the individual blocks (such openings as rooms, doors, and windows). Here, the inflow data of the aforementioned step 3 is added to the opening part sharing data.

In the setting of the inflow data by the aforementioned inflow data setting means 5 (step 4), the inlet•outlet is decided by subjecting the value of the flow (velocity of flow•direction of flow) entered by the user to the rule that the outside opening part facing the direction of wind constitutes the inlet and the inflow data inclusive of the inlet•outlet is added to the opening part sharing data prepared by the aforementioned opening part sharing data preparing means 4.

In the setting of the order of computation by the aforementioned computation order deciding means 6 (step 5), the order of computation of the flows through the individual inlets is decided based on the prepared opening part sharing data.

In the analytic computation by the aforementioned fluid flow analyzing means 7 (step 6), the computation is sequentially performed on the individual rooms along the course of flow of the fluid. When a plurality of inflows are involved, the analysis result stocking means 7a of the aforementioned fluid flow analyzing means 7 is made to stock the results of analysis obtained for the individual inflows with respect to a relevant room.

In the superpositioning of the results of computation by the aforementioned analysis result superpositioning means 7b (step 7), the results of analysis obtained of the individual rooms are stocked with respect to the separated inflows. Here, of the results of analysis so stocked, the results of analysis pertaining to one and the same rooms are selected. Since as many results of analysis stocked pertaining to one and the same room as the separated flows exist, these results of analysis are superpositioned. That is, the data (the x direction component, y direction component, and z direction component of the velocity of flow) pertaining to one and the same point in one and the same room is superpositioned as a vector. To cite a concrete computation, when two inflows are involved, for example, the final velocity components px, py, and pz at a certain point p are obtained by the following formula (In the formula, p1x denotes the x direction velocity component at the point p of the result of analysis pertaining to the inflow 1 and p2x denotes the X direction velocity component at the point p of the result of analysis pertaining to the inflow 2. Similarly, p1y and p2y denote the y direction velocity components at the point p and p1z and p2z denote the z direction velocity components at the point p). Optionally, the results of analysis obtained for the individual rooms and stored by the aforementioned analysis result stocking means 7a may be produced as a file on the aforementioned display means 9 so as to allow visual perception of the process of analytical computation of each of the blocks. In other words, the results of analysis obtained for the individual rooms with respect to the separated individual inflows are produced as a file. Of the individual files so produced, the files produced for one and the same room are selected. Since as many files produced for one and the same room as the separated flows exist, the results of analysis in these files are superpositioned.
pₓ=p₁ₓ+p₂ₓ
p_{y}=p_{1y}+p_{2y}
p_{z}=p_{1z}+p_{2z} Formula (5)

In the selection of the method of display (step 8), the way for displaying the state of flow of wind finally determined in the house is selected and executed. To be specific, a display method selecting means (not shown) displays on the aforementioned display means 9 a selected screen that enables selection among the display with a vector, the display with a streamline. When the user selects the display with a vector, for example, the display method selecting means responds to the relevant instruction and displays with arrow marks the directions and the velocities of flow at the individual places determined as described above (step 8 (a)). In the case of other selection, the display is made with streamlines particles (step 8 (b) or (c)). Incidentally, the display method selecting means mentioned above may be installed independently of the various means enumerated above or may be disposed on the aforementioned fluid flow analyzing means 7 as endowed with a function of serving as the display method selecting means mentioned above.

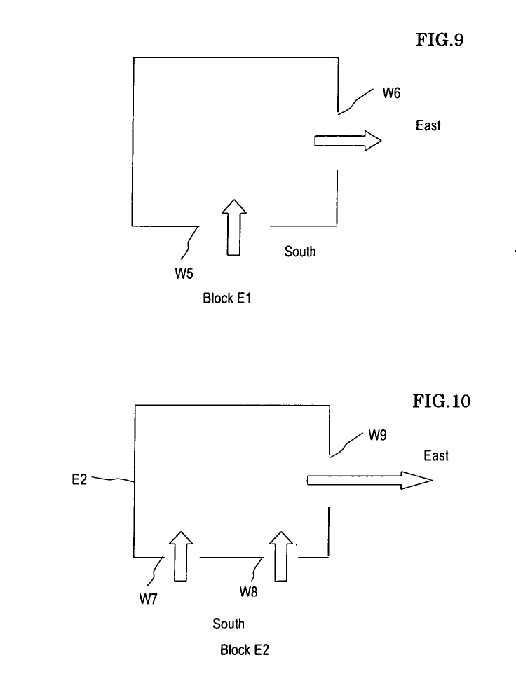

Now, the case of implementing fluid flow analysis within one room E1 by adopting the mode of the present embodiment will be explained next (FIG. 9). This room is provided on the south side and the east side thereof respectively with opening parts W5 and W6. It is assumed here that the opening part W5 forms an inlet and the opening part W6 an outlet. The analytical computation performed on this room E1 produces on a file the result of this analysis regarding the inflow through the opening part W5. Since this example involves one inflow, the formula for expressing the superpositioning is as shown by the formula (6). Thus, the result of analysis of this step 6 turns out to indicate the flow (velocity of flow-direction of flow) induced inside the room E1 by the fluid flowing in the room.
pₓ=p₁ₓ
p_{y}=p_{1y}
p_{z}=p_{1z} Formula (6)

Now, the case of implementing fluid flow analysis within a room E2 by adopting the mode of the present embodiment will be explained next (FIG. 10). This room is provided on the south side with opening parts W7 and W8 and on the east side with an opening part W9. It is assumed here that the opening parts W7 and W8 form inlets and the opening part W9 forms an outlet. As regards computation, the inflow through the opening part W7 and the inflow through the opening part W8 are severally subjected to analytical computation. At this time, the results of analysis respectively of these two inflows are produced as a file. Since this example involves two inflows, the formula for expressing the superpositioning is as shown by the formula (5) shown previously. The solution of this superpositioning turns out to indicate the flow (velocity of flow, direction of flow) induced inside the room E2 by the fluid flowing in the room.

The fluid flow in the room E2 mentioned above is analyzed by a process of subjecting each of the inflows to analysis and superpositioning the resultant solutions in view of the linearity of the analytical equation. The fluid flow analyzing system of this invention enables installation in an general personal computer instead of a computer of high performance because it allows a decrease in the amount of computation owing to the use of a simple linear equation as compared with the conventional fluid flow analyzing system that uses a nonlinear equation including a viscous term.

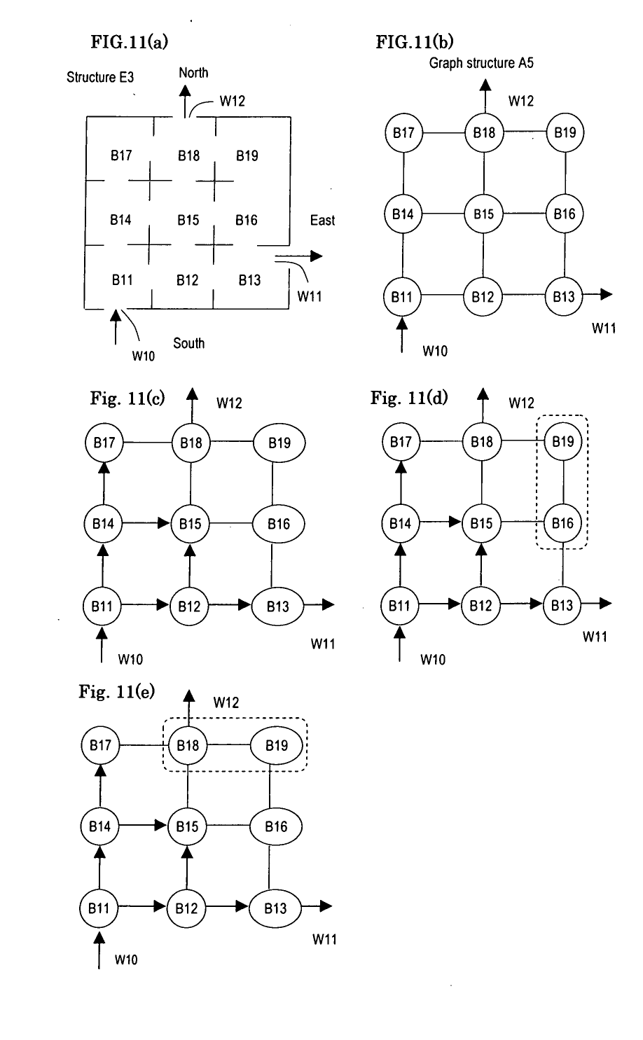

Now, the case of implementing fluid flow analysis within a structure E3 by adopting the mode of the present embodiment will be explained next (FIG. 11 (a)). The structure E3 is provided on the south side of a room B11 with an opening part W10, on the east side of a room B13 with an opening part W11, and on the north side of a room B18 with an opening part W12. First, in the steps 1 and 2 mentioned above, the internal shape of the structure is prepared and the dividing sizes of empty spaces are set. Next, in the steps 3 and 4, the opening part sharing data is prepared and the inflow data is added to the opening part sharing data. Here, the step 3 and the step 4 may be reversed in the sequence of process. To be specific, the inflow data is set in the step 4. Here, it is assumed that the wind is blowing from the south side. Then, the inflow data setting means 5 automatically decides the opening part W10 on the south side as an inlet and the opening part W11 on the east side and the opening part W12 on the north side as outlets. Next, in the step 3, the opening part sharing data is prepared. Then, the inflow data mentioned above is added to the opening part sharing data. Here, the opening part sharing data that has resulted from setting inflows-outflows through the opening parts can be represented as a graph structure A5 wherein the individual blocks are denoted with nodes and the opening parts shared by the blocks with edges (FIG. 11 (b)). Next, in the step 5, the order of computations is decided. Sequentially, from the room 11 having admitted the inflow of fluid onward, the aforementioned adjoining search encumbered with the condition concerning outlets is carried out. When the rooms B12 and B14 adjoining the room B11 are picked up, the order is {B11}, {B14, B12} because they both meet the condition. Next, when the rooms B17, B15, and B13 adjoining the rooms B14 and B12 are picked up, the order is {B11}, {B14, B12}, {B17, B15, B13} because they all pass the conditions. In this manner, the decision of the order of computations of the individual rooms proceeds (FIG. 11 (c)). It is the rooms B18 and B16 adjoining the rooms B17, B15, B13 that are picked up next. By checking the room B18 for the condition regarding the outlets, it is found that the other rooms not yet included in the order of computation are the rooms B16 and B19 (FIG. 11 (d)). Since the rooms B16 and B19 have no outlet anywhere, they do not satisfy the condition regarding the outlets and required for deciding the order of computation. On the other hand, by checking the room B16 for the condition regarding the outlets, it is found that the other rooms not yet included in the sequence of computation are the rooms 18 and B19 (FIG. 11 (e)). Since these rooms B18 and B19 have outlets therein, they satisfy the condition regarding the outlets mentioned above. Thus, the order of computation decided hereto is {B11}, {B14, B12}, {B17, B15, B13}, {B16}. The adjoining search is eventually continued from the room b16 and the final order of computation is decided as {B11}, {B14, B12}, {B17, B15, B13}, {B16}, {B19}, {B18}. Next, in the step 6, the individual rooms are successively subjected to analytical computation along this order of computation. In the step 7, the results of analysis produced in the files for the individual rooms are superpositioned. The solution resulting from this superpositioning turns out to indicate the flow (velocity of flow, direction of flow) induced in the structure by the fluid flowing in the structure.

(A recording medium capable of being read a computer having record therein a program enabling the computer to function as a fluid flow analyzing system and a computer data signal expressing the program, according to the present invention)

The mode of the present embodiment concerns a recording medium that is installed in a personal computer, for example, and is enabled to be read the computer having record therein a fluid flow analyzing program for causing the computer to function as the aforementioned fluid flow analyzing system 1 serving to simulate the phenomenon of flow in a structure. As concrete examples of the recording medium contemplated in the mode of this embodiment, CD-ROM (-R/-RW), magneto-optic disk, DVD-ROM, FD, flush memory, memory card, memory disk, and other various types of ROM and RAM may be cited. The recording medium in the mode of the present embodiment is installed as in a personal computer, adapted to implement analytical computation of the flow (velocity of flow, direction of flow) induced in a structure by the fluid flowing in the structure by using the aforementioned prescribed linear equation (Formula (1)), and made to have recorded therein a fluid flow analyzing program for imparting to the computer a fluid flow analysis step 6 capable of obtaining the result of the analysis. To be specific, the recording medium in the mode of the present embodiment causes the computer to function so as to be furnished with a structure internal shape preparing step 1 for preparing the internal shape of a structure, a mesh dividing step 2 for subjecting the interior of the structure to mesh division based on the internal shape prepared by the structure internal shape preparing step 1, an opening part sharing data preparing step 3 for preparing the opening part sharing data answering the question whether the adjacent individual blocks share an opening part based on the internal shape prepared by the structure shape preparing step 1, an inflow data setting step 4 for adding an inflow data to the aforementioned opening part sharing data, and a computation sequence deciding step 5 for deciding the sequence of computation of the individual blocks from the block the fluid flows in first to the block the fluid flows out last based on the opening part sharing data having already added the aforementioned inflow data and further has recorded therein a fluid flow analyzing program for enabling the computer to function so as to have the aforementioned fluid flow analyzing step 6 implement analytical computation of the flow in the rooms in accordance with the sequence decided by the computation sequence deciding step 5. The fluid flow analyzing program may be adapted to have the fluid flow analyzing system function as part of a CAD system, to have a fluid flow system function so as to include a CAD system as part of the function thereof, or to have the two systems function independently of each other. In the mode of this embodiment, when the computer is organized as the aforementioned fluid flow analyzing system 1, the coordinate data entered into the individual means (or produced from the individual means) of the system 1 can be reflected in the coordinate data of the CAD system. Thus, it is rendered possible to have the coordinate data of the aforementioned fluid flow analyzing system 1 visualized on the display means via the CAD system. Further, the mode of the present embodiment may be a computer data signal serving to express the fluid flow analyzing program mentioned above and adapted to be overlapped on the carrier wave. The program mentioned above may be contained in a memory unit of a server device on a network such as an internet, converted to the computer data mentioned above, overlapped on the carrier wave, transmitted to another computer using the network in common, and downloaded to the relevant computer.

Using the mode of the foregoing embodiment, even no matter how complicated building structure, the flow by the wind in the structure can be analyzed expeditiously and easily by returning the complicated problem to be the simple problem in single room, computing the flows along the flow direction, and superpositioning the result from each single room problem.

The disclosure of Japanese Patent Application No. 2006-053293 filed on Feb. 28, 2006 is incorporated as a reference.

While the invention has been explained with reference to the specific embodiments of the invention, the explanation is illustrative and the invention is limited only by the appended claims.

What is claimed is:

1. A method for the analysis of a fluid flow for simulating the phenomenon of flow of a fluid (gas or liquid) in a structure by a computer, characterized by being furnished with a fluid flow analyzing step adapted to subject the flow induced by a fluid flowing in the structure to analytical computation with the computer by using the following linear equation
$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$
and obtain the results of the analysis.

2. A method for the analysis of a fluid flow according to claim 1, which is furnished with a structure internal shape preparing step for preparing the internal shape of the structure, a mesh dividing step for subjecting the interior of the structure to mesh division, an opening part sharing data preparing step for preparing an opening part sharing data answering the question whether the adjoining rooms in the structure share an opening part based on the internal shape mentioned above, an inflow data setting step for adding the inflow data of the fluid in the opening parts to the opening part sharing data, and a computation order deciding step for deciding the order of computations from the room the fluid flows in first to the room the fluid room out last and is as well furnished with the fluid flow analyzing step for implementing analytical computation of the fluid flows in the individual room in accordance with the sequence of computations decided by the computation sequence deciding step mentioned above.

3. A method for the analysis of a fluid flow according to claim 2, wherein the inflow data setting step, when involving a plurality of set inlets, prepares a pattern having the relevant inlets open and the other inlets shut, the computation order deciding step decides the order of computations of the individual patterns, and the fluid flow analyzing step performs the aforementioned analytic computation in accordance with the sequence of computation for the individual patterns.

4. A method for the analysis of a fluid flow according to claim 2, wherein the computation order deciding step, in deciding the order of computations based on the opening part sharing data having already added the aforementioned inflow data and using as a basis a means for searching an adjoining block sharing an opening part with the room the fluid flows in first, is encumbered with the condition that the order of computations of the selected rooms is fixed only when an outlet exists at least one portion in the group of blocks other than the selected rooms.

5. A method for the analysis of a fluid flow according to claim 3, wherein the fluid flow analyzing step is furnished with an analysis result stocking step for stocking the results of analytic computations performed for the individual patterns and an analysis result superpositioning step for superpositioning the stocked results of analysis.

6. A fluid flow analyzing system for simulating with a computer the phenomenon of flow of a fluid in a structure, characterized by being furnished with a fluid flow analyzing means capable of subjecting the flow induced in a structure by the fluid flowing in the structure to analytic computation by using the following linear equation
$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$
and obtaining the results of the analysis.

7. A fluid flow analyzing system according to claim 6, which is furnished with a structure internal shape preparing means for preparing the internal shape of the structure, a mesh dividing means for subjecting the interior of the structure to mesh division, an opening part sharing data preparing means for preparing an opening part sharing data answering the question whether the adjoining rooms in the structure share an opening part based on the internal shape mentioned above, an inflow data setting means for adding the inflow data of the fluid in the opening parts to the opening part sharing data, and a computation order deciding means for deciding the order of computations from the room the fluid flows in first to the room the fluid flows out last and is as well adapted to have the fluid flow analyzing means implement analytic computations in the individual rooms in accordance with the sequence of computations decided by the computation sequence deciding means.

8. A fluid flow analyzing system according to claim 7, wherein the inflow data setting means, when involving a plurality of set inlets, prepares a pattern having the relevant inlets open and the other inlets shut, the computation order deciding means decides the order of computations of the individual patterns, and the fluid flow analyzing means performs the aforementioned analytic computation in accordance with the order of computation for the individual patterns.

9. A fluid flow analyzing system according to claim 7, wherein the computation order deciding means, in deciding the order of computations based on the opening part sharing data having already added the aforementioned inflow data and using as a basis a means for searching an adjoining room sharing an opening part with the room the fluid flows in first, is encumbered with the condition that the sequence of computations of the selected blocks is fixed only when an outlet exists at least one portion in the group of rooms other than the selected blocks.

10. A fluid flow analyzing system according to claim 8, wherein the fluid flow analyzing means is furnished with an analysis result stocking means for stocking the results of analytic computations performed for the individual patterns and an analysis result superpositioning means for superpositioning the stocked results of analysis.

11. A fluid flow analyzing system according to claim 6, wherein at least one of the means enumerated above can be connected to a computer-aided design (CAD) system and is capable of converting the coordinate data input into the CAD system to a coordinate data for at least one of the individual means mentioned above, converting the coordinate data from the at least one of the individual means to a coordinate data for the CAD system, and displaying graphically the coordinate data on a display means.

12. A recording medium capable of being read from a computer having record therein a program for functioning the computer as a fluid flow analyzing system for simulating the phenomenon of flow of a fluid in a structure, characterized by having record therein a fluid flow analyzing program for inducing the flow in a structure by the fluid flowing in the structure to be subjected to analytical calculation using the following linear equation:
$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$
and functioning the computer so as to be furnished with a fluid flow analyzing step for obtaining the results of analysis.

13. A recording medium according to claim 12, wherein the fluid flow analyzing program recorded therein functions the computer so as to be furnished with a structure internal shape preparing step for preparing the internal shape of the structure, a mesh dividing step for subjecting the interior of the structure to mesh division, an opening part sharing data preparing step for preparing an opening part sharing data answering the question whether the adjoining blocks in the structure share an opening part based on the internal shape mentioned above, an inflow data setting step for adding the inflow data of the fluid in the opening parts to the opening part sharing data, and a computation sequence deciding step for deciding the sequence of calculations from the room the fluid flows in first to the room the fluid flows out last and as well furnished with the fluid flow analyzing step for implementing analytical calculation of the fluid flows in the individual rooms in accordance with the sequence of calculations decided by the calculation sequence deciding step mentioned above.

14. A computer data signal expressing a program for functioning a computer as a fluid flow analyzing system for simulating the phenomenon of flow of a fluid in a structure and adapted to be overlapped on a carrier wave, characterized by expressing a fluid flow analyzing program for having the computer furnished with a fluid flow analyzing step for subjecting the flow induced in a structure by the fluid flowing in the structure to analytical calculation using the following linear equation
$$\frac{{\partial }^{2} Φ}{\partial {x}^{2}} + \frac{{\partial }^{2} Φ}{\partial {y}^{2}} + \frac{{\partial }^{2} Φ}{\partial {z}^{2}} = 0 \qquad Formula ( 1 )$$
and obtaining the results of the analysis.
